(19) United States
(12) Patent Application Publication
(10) Pub. No.: US 2016/0066496 A1
(43) Pub. Date: Mar. 10, 2016

(54) System and Method for Turf Aeration

(71) Applicant: Trigon Turf Sciences LLC, Miami, FL (US)

(72) Inventors: Thomas N. Tremblay, JR., Miami, FL (US); Jason N. Ticknor, Naples, FL (US)

(73) Assignee: TRIGON TURF SCIENCES LLC, Miami, FL (US)

(21) Appl. No.: 14/791,309

(22) Filed: Jul. 3, 2015

Related U.S. Application Data
(60) Provisional application No. 62/047,100, filed on Sep. 8, 2014.

(51) Int. Cl. A01B 1/24; A01B 45/02

(52) U.S. Cl. CPC A01B 1/243; A01B 45/02

(57) ABSTRACT

A fluid injection system includes a pressurized fluid source operatively coupled to an injector, the injector including a handle, frame and spike portions; a fluid inlet proximate the handle portion; a fluid outlet proximate the distal tip of the spike portion; and a fluid pathway extending between the inlet and the outlet, so that upon insertion or removal of the spike portion at a desired location fluid may be delivered as desired.

### FIELD OF THE DISCLOSURE

The invention relates generally to a fluid injection apparatus and a method for providing fluid to turf using such apparatus, and more particularly in one exemplary embodiment, to systems and methods including use of an air injection apparatus to aerate golf course greens and other areas.

### BACKGROUND

Golf course greens constructed in accordance with US Golf Association (USGA) standards are sand-based. The uppermost portions of such greens include a rootzone mix covering a layer of sand. When grass is planted on a rootzone mix, the soil physical properties change over time as a result of natural root growth cycles. Roots grow down through the soil in large soil pores (macropores). The roots provide the grass plant with the water, oxygen, and nutrients needed for growth. But over time, these macropores begin to diminish. Compaction, organic material, deposits from irrigation water, etc. all reduce the amount of macropores over time. There is less space in the soil profile for roots to establish. The turf suffers due to a lack of oxygen.

For convenience only, reference is made herein to applications involving golf course turf, and in particular golf course greens and related areas. However, the invention is not so limited. One of ordinary skill in the art, having the benefit of this disclosure, will recognize its applicability not only for golf course greens, but also golf course fairways and tees, sports fields (e.g., baseball fields, soccer fields (e.g. goalie boxes)), and other areas where turf compaction in particular is especially a problem.

Further, for convenience only reference is primarily made herein to systems and methods including the use of pressurized air. However, other fluids (water, liquid fertilizers, fungicides (particularly those meant for the soil that have a difficult time penetrating turf), carbon dioxide, nitrogen, etc.) may also be injected in accordance with the systems and methods described herein. Thus, the invention is not limited to those examples involving turf aeration.

For golf course greens, core aeration at depths of three inches or greater is used to remove organic matter from rootzones and to create additional macropores that promote grass growth. However, core aeration has its drawbacks. Often golf course greens are unusable after core aeration, or at a minimum core aeration makes the green surface rough for golf play. In addition, large core aeration equipment cannot get close to areas such as sidewalks, valve boxes, sprinkler heads, etc., so many turf areas on a course go untreated. Thus, an additional or improved method for turf aeration and for creating macropores in golf course greens and other turf areas is desirable.

### SUMMARY

The present disclosure provides air injection systems and methods for turf aeration and macropore creation. In one exemplary embodiment, an air injection system includes a source of compressed air fluidly coupled to an air injector. The air injector includes: (a) a handle portion; (b) a spike portion operatively coupled and distal to the handle portion; and (c) an air pathway. The air pathway extends from an inlet disposed proximate the handle portion to a plurality of exit ports positioned on the spike portion. The inlet is fluidly coupled to the compressed air source. The spike portion is adapted to be removably insertable into turf. The air pathway includes a selector switch and valve for selectively providing air from the compressed air source out the exit ports to locations proximate turf desired to be aerated.

Other benefits and advantages of the present disclosure will be appreciated from the following detailed description.

### DESCRIPTION OF THE DRAWINGS

FIG. 1 is an exemplary embodiment of an air injector system.

FIG. 2 is an exemplary embodiment of a portion of the air injector system shown in FIG. 1, including in one aspect a handle portion.

FIG. 3 is an exemplary embodiment of a portion of the air injector system shown in FIG. 1, including in one aspect a spike portion.

FIG. 4 is an exemplary embodiment of a portion of the air injector system shown in FIG. 1, including in one aspect the operable coupling of a spike portion to a frame portion.

FIG. 5 is an alternate perspective view of the portion of the air injector system shown in FIG. 4.

FIG. 6 is an exemplary embodiment of a portion of the air injector system shown in FIG. 1, including in one aspect the tip portion of the spike portion.

FIG. 7 is an exemplary embodiment of a portion of the air injector system shown in FIG. 1, including in one aspect depth markers disposed along an exemplary length of the spike portion.

FIG. 8 is an exemplary embodiment of a portion of the air injector system shown in FIG. 1, including in one aspect the operable coupling of a frame portion to a handle portion.

FIG. 9 is an exemplary embodiment of a portion of the air injector system shown in FIG. 1, including in one aspect one handle portion operably coupled to the frame portion, the handle portion including among other things a compressed air inlet.

FIG. 10 is an exemplary embodiment of a portion of the air injector system shown in FIG. 1, including in one aspect a valve and switch assembly for controlling the flow of pressurized air along a fluid pathway extending from the air inlet to the tip portion.

FIG. 11 is an exemplary embodiment of an air injection system illustrating the insertion and removal of the tip portion from a portion of a grounds area desired to be aerated.

FIG. 12 is an exemplary embodiment of an inlet portion of an air injector system, including in one aspect a hose connector.

FIG. 13 is an exemplary embodiment of an adjustable pressure plate adapted for use with an air injection system.

FIG. 14 is an exemplary view of an adjustable pressure plate disposed proximate the distal end of an air injector.

FIG. 15 is an exemplary view of an air injector inserted at a turf area up to an adjustable pressure plate.

### DETAILED DESCRIPTION

Embodiments of the invention and various alternatives are described. Those skilled in the art will recognize, given the teachings herein, that numerous alternatives and equivalents exist which do not depart from the invention. It is therefore intended that the invention not be limited by the description set forth herein or below.

One or more specific embodiments of the system and method will be described below. These described embodiments are only exemplary of the present disclosure. Additionally, in an effort to provide a concise description of these exemplary embodiments, all features of an actual implementation may not be described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

Further, for clarity and convenience only, and without limitation, the disclosure (including the drawings) sets forth exemplary representations of only certain aspects of events and/or circumstances related to this disclosure. Those skilled in the art will recognize, given the teachings herein, additional such aspects, events and/or circumstances related to this disclosure, e.g., additional elements of the devices described; events occurring related to turf aeration; etc. Such aspects related to this disclosure do not depart from the invention, and it is therefore intended that the invention not be limited by the certain aspects set forth of the events and circumstances related to this disclosure.

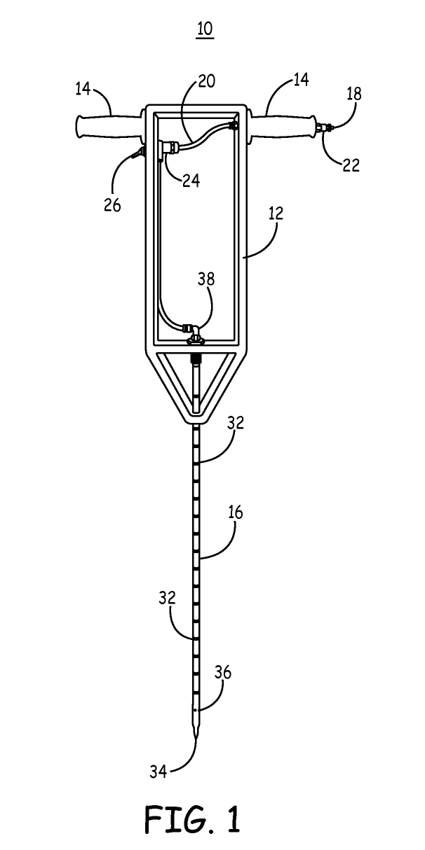

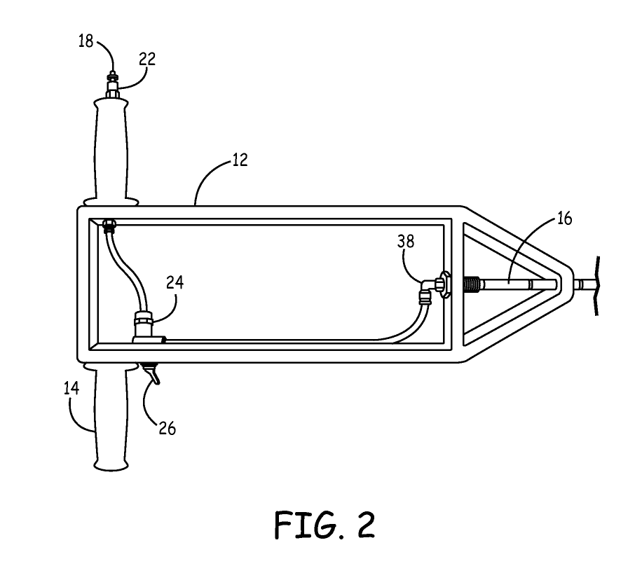

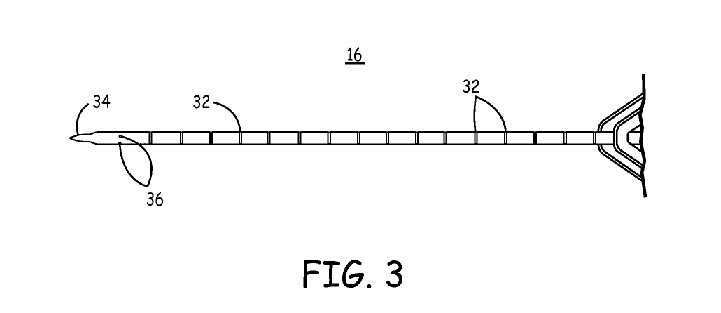

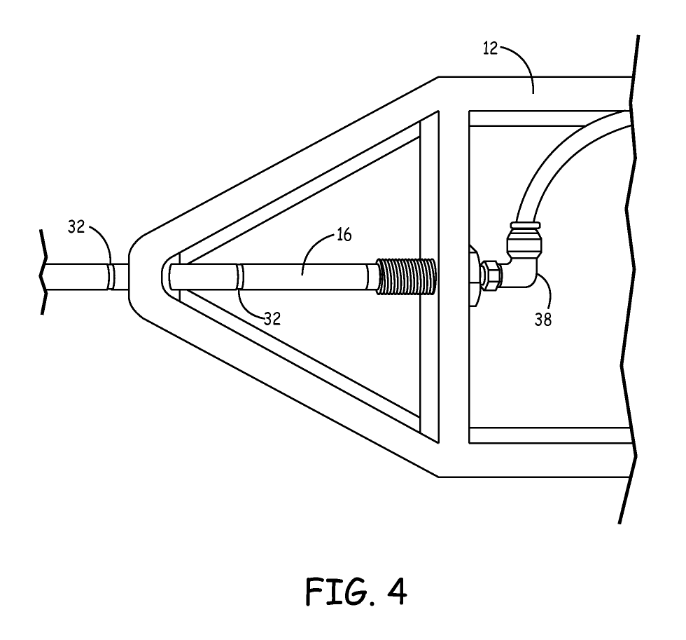

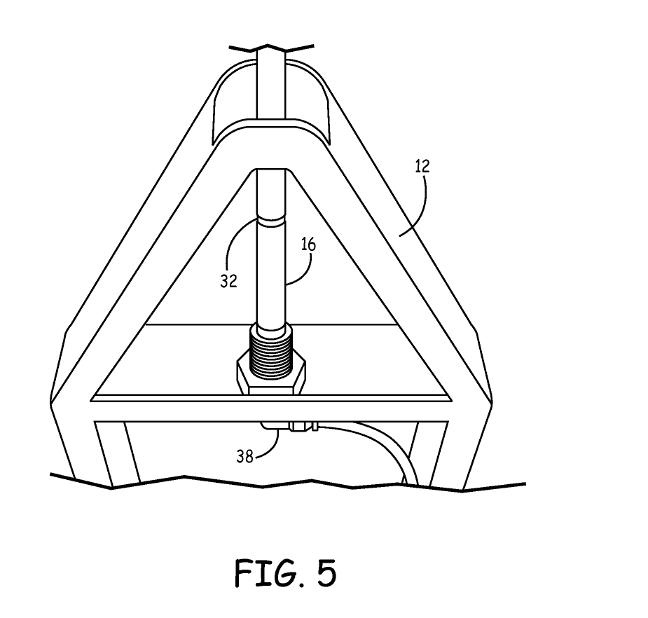

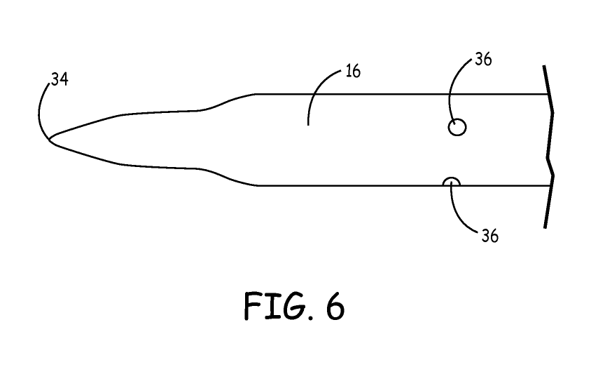

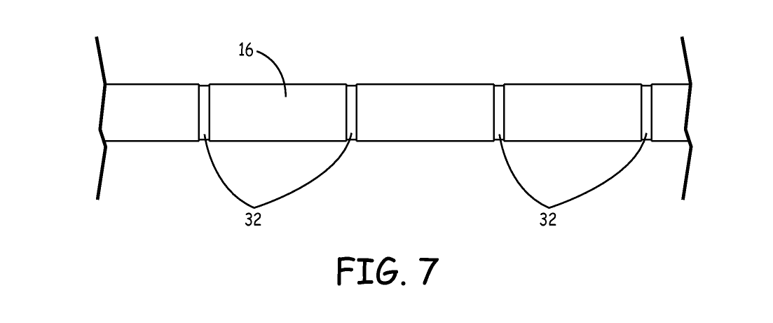

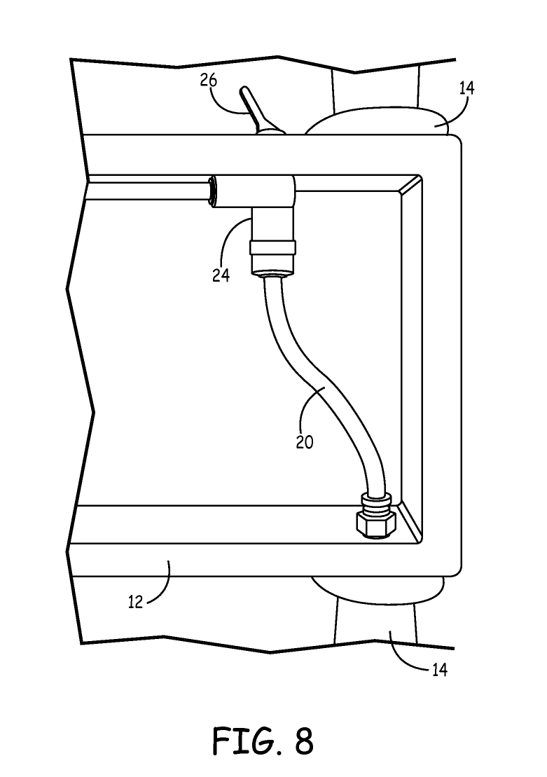

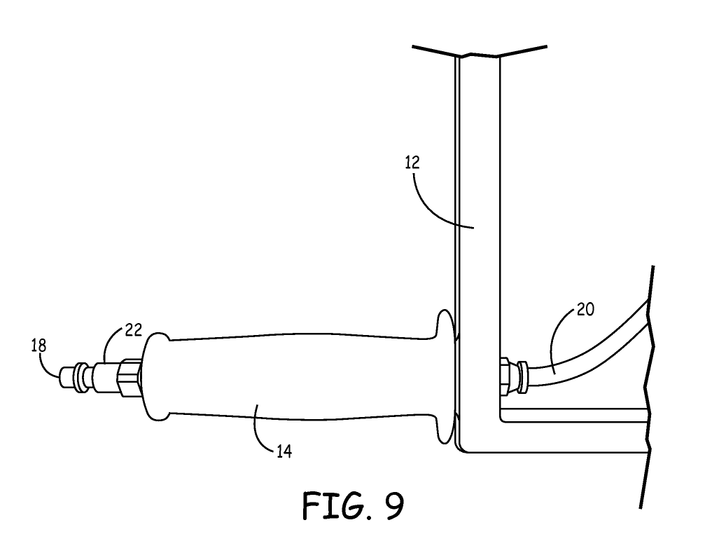

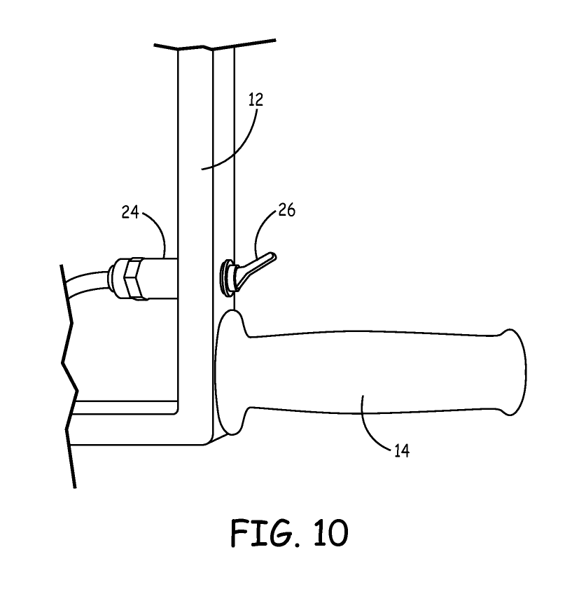

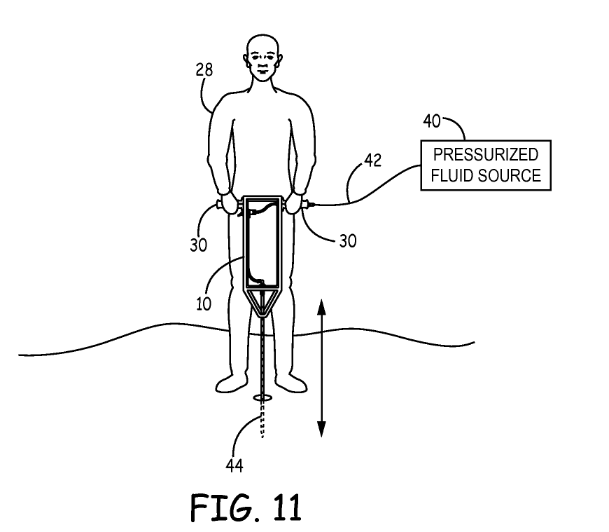

Turning now to the drawings, FIGS. 1 through 10 shows an exemplary air injector 10. The air injector 10 comprises a frame portion 12 that operatively couples a handle portion 14 to a spike portion 16. In one exemplary embodiment, the handle portion 14 includes two grips 30 that a user of the system may grasp by hand. Proximate the handle portion 14 is an inlet 18 for air provided from a compressed air source (not shown in FIG. 1; see, e.g., FIG. 11) that is coupled to an air pathway 20 with a connector 22. The inlet 18 is in fluid communication with the air pathway 20. The air pathway 20 extends from the inlet 18 to the spike portion 16 of the air injector 10. Along the air pathway 20 a valve 24 and switch 26 is provided to control selectively the air supplied to the spike portion 16. The valve 24 and switch 26 may include a two-position valve that opens or closes, so that air is provided to the spike portion 16 as desired at the approximate pressure of the compressed air source. Alternately, the valve 24 and switch 26 may step down the air pressure to a desired operating pressure. When the valve 24 is fully closed, no air is provided to the spike portion 16. In one exemplary embodiment, the valve 24 and switch 26 is disposed proximate a grip for ease of access by a user 28.

As shown in FIG. 11, the handle portion 14, frame portion 12 and spike portion 16 of the air injector 10 in one exemplary embodiment are advantageously rigidly formed, so that a user 28 may insert a portion of the spike portion 16 beneath turf by simply holding the grips 30 and pressing the spike portion 16 downward. In one embodiment, the spike portion 16 includes depth markers 32 spaced along its length, so that a user 28 may easily ascertain the depth of insertion of the spike. To remove the spike portion 16, the user 28 simply pulls the spike portion 16 in the opposite (upward) direction. To facilitate insertion into turf, the spike portion 16 may include a pointed tip 34, as shown for example in the drawings.

In one exemplary embodiment, the spike portion 16 provides fluid communication between the air pathway 20 and a plurality of exit ports 36, which may be disposed along a portion of the length of the spike portion 16. In another exemplary embodiment, the exit ports 36 are located on the spike portion 16 proximate its tip 34. A distal connector 38 operatively couples the air pathway 20, which may comprise rubber, plastic, or other tubing, with the spike portion 16, which may comprise a metal conduit. The exit ports 36 may be arranged in any desired configuration, depending upon the circumstances involved in a particular application. In one exemplary embodiment, exit ports 36 may be disposed at multiple locations along a portion of the length of the spike portion 16, with each location including four exit ports 36 spaced ninety degrees from each other about the circumference of the spike portion 16 at the location. In another exemplary embodiment, one or more exit ports 36 are located at a single location along the length of the spike portion 16, proximate the tip 34. The total number of exit ports 36 and their location(s) may depend upon the circumstances involved in a particular application.

Use of the air injector 10 includes coupling the air injector 10 to a source of compressed air 40 via line 42 (see FIG. 11). The spike portion 16 of the air injector 10 is positioned and inserted proximate a turf area 44 to be aerated. A user 28 then may activate the flow of compressed air through the air injector 10 through operation of the switch 26 and valve 24. Compressed air flows from the inlet 18 to the spike portion 16 via the air pathway 20. At the spike portion 16, the compressed air exits the air injector 10 via a plurality of exit ports 36. The ejected air has the effect of mixing the contents of the turf area 44 proximate the air injector 10 and of forming macropores to help promote root growth. The ejected air is under pressure and fractures the soil, creating macropores. The pressurized air travels through paths of relatively low resistance in the soil.

In one exemplary embodiment, use of the air injector 10 includes the step of supplying air proximate turf 44 to be aerated as the spike portion 16 of the air injector 10 is slowly removed from its inserted location. Once the spike portion 16 is completely removed from the turf, the user 28 again may activate the valve 24 and switch 26 to stop the flow of air through the air injector 10. The air injector 10 is then positioned at another location, and the air injection process is repeated.

In an alternate method, air may be supplied to the exit ports 36 as the spike portion 16 is being inserted proximate turf 44 to be aerated. In yet a further exemplary embodiment, air flow to the exit ports 36 may be stopped before the spike portion 16 of the air injector 10 is removed from its insertion location. The steps actually performed will of course depend upon the circumstances involved in a particular application.

In an alternate method, the fluid supplied to the injector 10 may be a pressurized liquid. In such cases, the connector 22, distal connector 38, switch 26, valve 24, and air pathway 20 should be selected to handle the operational requirements associated with the delivery of pressurized liquids.

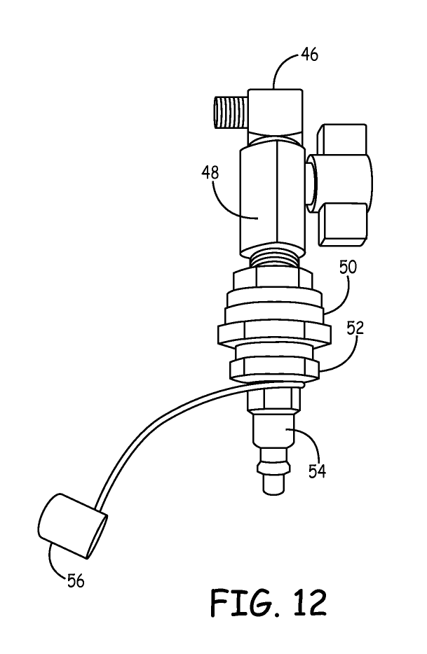

As shown in FIG. 12, an exemplary injector may be configured at its inlet with a pressure regulating valve 48 operatively coupled to the injector via elbow 46. Also coupled to the valve 48 is a female hose connector 50. In many instances, a source of pressurized liquid may be connected via a standard hose directly to connector 50. Or for gas delivery, and adapter 52 may couple the connector 50 to a standard air fitting 54, which may include a cap 56. In addition, the adapter 52 may be alternately fitted with a ½ inch fitting to mate with the quick connectors on many of the commercially available spray rigs. In that way, a user has the flexibility to inject directly from the spray rigs, and thus may inject fertilizers, fungicides, chemicals, etc. Examples of liquids that might be provided include (without limitation) water, liquid fertilizers, fungicides, and nutritional supplements. In that way, such liquids may be directly delivered proximate the roots of the turf to be treated.

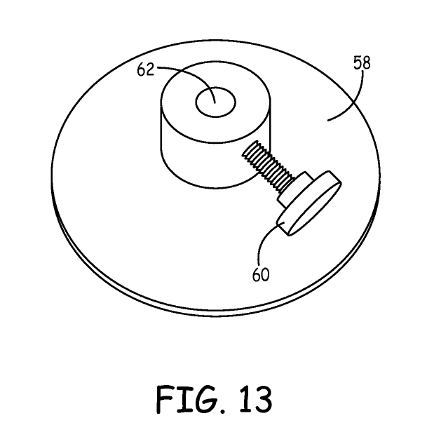

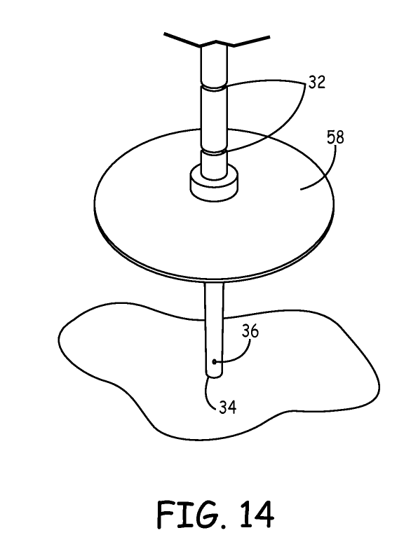

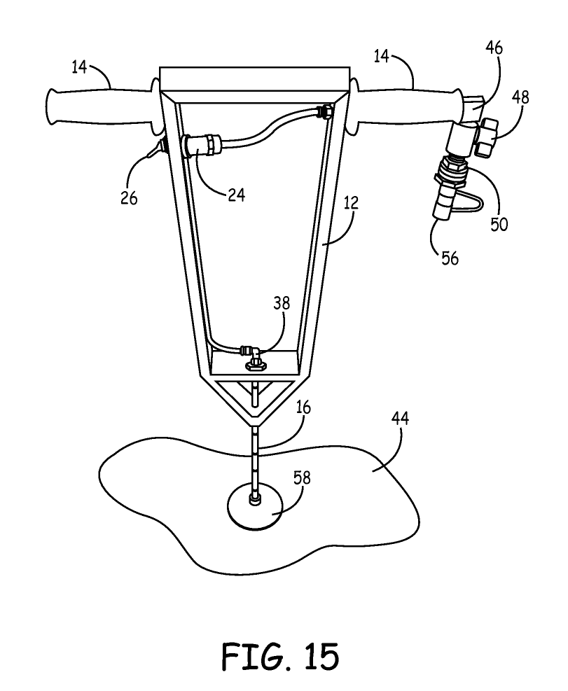

FIG. 13 shows an exemplary adjustable pressure plate for use with the air injector system. The adjustable pressure plate includes a substantially planar portion 58 operable coupled to a means for coupling the pressure plate proximate the distal end of an air injector. See, e.g., FIG. 14. As shown, a thumb screw or set screw 60 is configured to removably secure the planar portion 58 at a desired location along the length of spike portion 16, e.g., at a desired depth mark 32. The planar portion 58 may apply downward pressure to a portion of the turf 44 being treated, to help prevent heaving of a portion of the turf 44 being treated that is proximate to the spike portion 16. See FIG. 15. The planar portion 58 also enables the air injector to be inserted to consistent depths for multiple insertions during use.

In general, then, localized areas of turf that suffer (e.g., due to compaction, lack of oxygen, minimal macropore spaces, lack of nutritional supplements) may be directly remediated rapidly in accordance with the system and method described herein.

It should be understood that the foregoing description is only illustrative of the invention. Various alternatives and modifications can be devised by those skilled in the art having the benefit of this disclosure, without departing from the invention. Accordingly, the invention is intended to embrace all such alternatives, modifications and variances.

Certain exemplary embodiments of the disclosure may be described. Of course, the embodiments may be modified in form and content, and are not exhaustive, i.e., additional aspects of the disclosure, as well as additional embodiments, will be understood and may be set forth in view of the description herein. Further, while the invention may be susceptible to various modifications and alternative forms, specific embodiments have been shown by way of example in the drawings and will be described in detail herein. However, it should be understood that the invention is not intended to be limited to the particular forms disclosed. Rather, the invention is to cover all modifications, equivalents and alternatives falling within the spirit and scope of the invention.

1. A fluid injection system including: a pressurized fluid source operatively coupled to an injector, the injector including:
a handle portion,
a frame portion,
a spike portion,
a pressure plate attached to the spike portion,
a fluid inlet proximate the handle portion,
a fluid outlet proximate a distal tip of the spike portion,
a fluid pathway extending between the fluid inlet and the fluid outlet, the fluid pathway including a valve operable to control the flow of fluid through the fluid pathway,
wherein during insertion or removal of the spike portion at a desired location fluid from the pressurized fluid source is delivered to the location.

2. The fluid injection system of claim 1, wherein the pressurized fluid source is a pressurized gas source.

3. The fluid injection system of claim 1, wherein the pressurized fluid source is a pressurized liquid source.

4. The air injection system of claim 2, further including proximate the handle portion a switch operable to open and close the valve.

5. The air injection system of claim 2, further including a plurality of depth markers disposed along a length of the spike portion.

6. The air injection system of claim 2, wherein the fluid outlet includes a plurality of fluid ports spaced along a length of the spike portion.

7. The air injection system of claim 2, wherein the fluid outlet includes a plurality of fluid ports spaced about a circumference of the spike portion.

8. The air injection system of claim 7, wherein four fluid ports are spaced at approximately ninety degree intervals.

9. The air injection system of claim 2, wherein the desired location is a turf area.

10. A fluid injector including:
a handle portion,
a frame portion,
a spike portion,
a pressure plate attached to the spike portion,
a fluid inlet proximate the handle portion,
a fluid outlet proximate a distal tip of the spike portion,
a fluid pathway extending between the fluid inlet and the fluid outlet, the fluid pathway including a valve operable to control the flow of fluid through the fluid pathway,
wherein during insertion or removal of the spike portion at a desired location fluid at the fluid inlet is deliverable to the location.

11. The fluid injector of claim 10, wherein the fluid injector further includes:
proximate the handle portion, a switch operable to open and close the valve;
a plurality of depth markers disposed along a length of the spike portion; and
a plurality of fluid ports spaced about a circumference of the spike portion.

12. The fluid injector of claim 11, wherein two fluid ports are spaced about ninety degrees apart.

13. The fluid injector of claim 11, wherein two fluid ports are spaced about one hundred eighty degrees apart.

14. A turf treatment method including the steps of:
(a) providing a fluid injection system including a fluid injector operably coupled to a source of pressurized fluid; the fluid injector including a handle portion, a frame portion, a spike portion, a pressure plate attached to the spike portion, a fluid inlet, a fluid outlet proximate a distal tip of the spike portion, a fluid pathway extending between the fluid inlet and the fluid outlet, the fluid pathway including a valve operable to control the flow of fluid through the fluid pathway;
(b) providing fluid from the pressurized fluid source to the turf to be treated via the fluid injector at a desired time.

15. The method of claim 14, wherein the desired time is during insertion of the spike portion into the turf.

16. The method of claim 14, wherein the desired time is after insertion of the spike portion into the turf.

17. The method of claim 14, wherein the desired time is during withdrawal of the spike portion from the turf.

18. The method of claim 14, wherein the fluid is air.

19. The method of claim 14, wherein the fluid includes water.

20. The method of claim 18, further including the step of forming macropore spaces in the turf.

21. The system of claim 1, wherein the pressure plate is positionable along the length of the spike portion.

22. The fluid injector of claim 10, wherein the pressure plate is positionable along the length of the spike portion.
